(19) United States
(12) Patent Application Publication
(10) Pub. No.: US 2016/0136861 A1
(43) Pub. Date: May 19, 2016

(54) SCREW ELEMENTS FOR MULTI-SHAFT SCREW-TYPE MACHINES

(71) Applicant: COVESTRO DEUTSCHLAND AG, Leverkusen (DE)

(72) Inventor: Thomas KÖNIG, Leverkusen (DE)

(21) Appl. No.: 14/899,771

(22) PCT Filed: Jun. 20, 2014
(86) PCT No.: PCT/EP2014/062981

§ 371 Date: Dec. 18, 2015

(30) Foreign Application Priority Data
Jun. 24, 2013 (EP) 13173337.0

(51) Int. Cl. B29C 47/08; B29B 7/46; B29C 47/40

(52) U.S. Cl. CPC B29C 47/0844; B29C 47/402; B29C 47/0861; B29B 7/46

(57) ABSTRACT

The invention relates to screw elements (10, 10′) for multi-shaft screw-type machines having screw shafts (W, W′) rotating pairwise in the same direction, wherein said screw elements scrape off one another precisely and the screw shafts composed of said screw elements have two or more screw flights. The screw profiles (11, 11′) can be represented over the entire cross section by respective profile curves, each profile curve (11, 11′) having at least one inflection point (K, K′) lying inside an outer radius (RA, RA′) of the profile curve over the progression thereof. The inflection point is considered to be a position of an abrupt change of pitch or a geometrical discontinuity in the pitch of the profile curve. The invention further relates to a method for producing screw elements (10, 10′), wherein circular arcs (1-5) are combined into a curve to form the screw profiles (11, 11′), the curve having at least one inflection point (K, K′) or one point of discontinuity in the pitch of the curve over the progression thereof, said point (K, K′) lying inside an outer radius (RA, RA′) of the profile curve. The invention additionally relates to screw-type machines having the screw elements according to the invention. The invention further relates to the use of screw elements according to the invention for extruding plastic materials.

The invention relates to screw elements for multi-shaft screw machines with paired co-directionally rotating screw shafts, use of the screw elements in multi-shaft screw machines and a method for extruding plastic compositions using these screw elements and also a method for producing the screw elements.

Co-directionally rotating two- or possibly multi-shaft machines, the rotors of which fully wipe one another, have been known already for some considerable time (see for example DP 862 668). In polymer preparation and processing, screw machines which are based on the principle of fully wiping profiles have been put to varied use. This is based in particular on the fact that polymer melts adhere to surfaces and, under customary processing temperatures, degrade over time, which is prevented by the self-cleaning effect of the fully wiping screws. Rules for producing fully wiping screw profiles are presented, for example, in [1] ([1]=Klemens Kohlgrüber: “Der gleichläufige Doppelschneckenextruder” [the co-running twin-screw extruder], Hanser Verlag Munich 2007 pages 96-109). It is also described that a predetermined screw profile on the first shaft of a twin-screw extruder determines the screw profile on the second shaft of the twin-screw extruder ([1], page 97). The screw profile on the first shaft is therefore referred to as the generating screw profile, The screw profile on the second shaft follows from the screw profile of the first shaft of the twin-screw extruder and is therefore referred to as the generated screw profile. In the ease of a multi-shaft extruder, the generating screw profile and the generated screw profile are always used alternately on adjacent shafts. Modern twin-screw extruders have a modular system, in which different screw elements can be drawn onto a core shaft. This allows a person skilled in the art to adapt the twin-screw extruder to the respective process task.

In the prior art there are known screw elements in which a kink occurs in the cross-sectional profile at the flight land of the screw and forms an abrupt transition with the flank of the flight, the flight land comprising an arc with a radius=outside diameter of the profile, with the point of rotation of the profile as the center point. This kink at the transition to the flank of the profile forms an edge on the screw element. One of the main tasks carried out on multi-shaft machines is the dispersing of liquid phases or melts that cannot be homogeneously mixed with one another or the dispersing of solids in polymer melts. It is known from the technical literature (see for example Chang Dae Han: “Multiphase Flow in Polymer Processing”, Academic Press, New York 1981) that a combination of shear flow and stretching flow is optimal for difficult dispersing tasks. Such a form of flow exists in a screw channel, where the material is on the one hand sheared by the rotation of the shafts and on the other hand simultaneously stretched by the convergence of the screw channel toward the flight land. In the region of the flight land of the screw, however, there is purely shear flow, which in the case of difficult dispersing tasks will scarcely contribute to the dispersion. On the other hand, the greatest part of the energy introduced is dissipated in the gap between the flight land of the screw and the barrel or the adjacent shaft. Therefore, this region contributes significantly to the heating up of the polymer composition, and consequently potentially to thermal degradation, without providing any contribution to the process task of dispersion. Eccentrically arranged circular disks, for which it is known that they can be arranged in a fully wiping manner, represent an exception. They do not have any flight land region with purely shear flow. They are known for their excellent dispersing effect, but likewise have a high energy input, because they produce a very narrow gap over a large circumferential region. Furthermore, they are restricted to a number of flights of Z=1.

International patent applications WO 2009/152968 A1 and WO 2011/069896 A1, the entire content of which is hereby incorporated by reference in the present application, also describe screw elements for multi-shaft screw machines with pairs of co-directionally rotating screw shafts. These screw elements were developed to have profiles in the axial cross section that can be represented by continuously differentiable profile curves, in order to counter the aforementioned problems. However, this does not yet achieve an optimum performance of the screw elements in all application areas.

European patent application EP 1093905 A2, which inter alia discloses twin-screw extruders, already addresses the problem of avoiding the dissipative heating up of the material to be extruded with a high dispersive and distributive mixing effect, but only offers an inadequate solution.

German patent application DE 102008026862 A1 is also concerned with improving the dispersive and distributive mixing effect in the case of multi-shaft extruders, but does not address the problem of dissipative heating up of the material to be extruded.

Although European patent application EP 087536 A2 focuses on the one hand on an improvement in the dispersive and distributive mixing effect in the case of multi-shaft extruders and on the other hand on gentle processing, it does not focus on an improvement in the dispersive and distributive mixing effect in combination with gentle processing.

European patent application EP 0002131 A1 discloses multi-shaft extruders with an improved kneading action on plastics. However, this patent application neither addresses the improvement of the dispersive or distributive mixing effect nor addresses the problem of the dissipative heating up of the material to be extruded.

International patent application WO 2001/006516 A1 discloses multi-shaft extruders with an improved dissipative mixing effect. However, this patent application also does not address the problem of the dissipative heating up of the material to be extruded.

Therefore, on the basis of the prior art, the object is to provide screw elements for multi-shaft screw machines that have an improved dispersing effect in comparison with the prior art with as little energy input as possible.

The object is achieved according to the invention by screw elements for multi-shaft screw machines with the features of claim 1 and by a method for producing these screw elements with the features of claim 10. Preferred refinements and applications for the invention are specified in the subclaims and further independent claims.

It has surprisingly been found that the object is achieved by screw elements of which the profile can be represented over the entire cross section by a profile curve that is not continuously differentiable but has a kink along it that lies within an outer radius of the profile curve, the ratio of a radius of curvature of the screw profile to the outer radius of the profile being 0.05 to 0.95. This applies in particular at the point P_{A}, which cleans off the barrel. The kink is considered to be a location of abrupt change in slope or geometrical discontinuity in the slope of the profile curve. Furthermore, the term “within an outer radius of the profile curve” means that the kink does not lie on the outer radius of the profile curve, but at a location with a radius which, from the point of rotation or from the axis of rotation of the respective screw element, is smaller than the outer radius of the profile curve.

In a preferred embodiment of the invention, the ratio of the radius of curvature of the screw profile to the outer radius of the profile is 0.2 to 0.8, preferably 0.3 to 0.7, particularly preferably 0.35 to 0.65. This applies in particular at the point P_{A}, which cleans off the barrel. If the profile curve is made up in portions of various functions, the radius of curvature may possibly be discontinuous, i.e. the limit value of the radius of the curve for values when approaching a point in one direction of rotation is different than when approaching a point in the opposite direction of rotation. If such a transition is specifically at the outer radius of the profile, the preferred ranges preferably apply to-at least one of the two limit values.

The subject matter of the invention is therefore screw elements for multi-shaft screw machines with paired co-directionally rotating screw shafts, these screw elements being fully wiping in pairs and screw shafts that are made up of these screw elements having two or more screw flights, the generating and generated screw profiles being able to be represented over the entire cross section in each case by a profile curve that has at least one kink or geometrical discontinuity in the slope of the profile curve, characterized in that the at least one kink or the at least one discontinuity does not lie at the outer radius of the profile curve, the ratio of a radius of curvature of the screw profile to the outer radius of the profile being 0.05 to 0.95. This applies in particular at the point P_{A}, which cleans off the barrel. The screw elements according to the invention are intended always to be in contact with one another at at least one point when rotating in the same direction at the same rotational speed about two axes of rotation arranged parallel to one another at a distance a.

At the same time, the invention is not restricted to screw elements comprising the nowadays customary modular construction of a screw from screw elements and core shafts, but can also be applied to screws of a solid construction. Therefore, the term screw elements is to be understood as also meaning screws of a solid construction. Although the at least one kink forms an edge in the profile of the screw element, it does not lie at the flight land of the screw but is offset radially inward, so that it can contribute to the dispersion of the polymer composition without making a considerable contribution to heating it up.

In a preferred embodiment of the invention, the cross-sectional profiles (hereinafter referred to as profiles or else screw profiles for short) of the screw elements according to the invention can be represented by a continuously differentiable curve over their entire length apart from said at least one kink. Preferably, the portions of the continuously differentiable profile curves are generated by the method described in WO 2011/069896 A1.

As already mentioned above with reference to the generating and generated screw profiles, the cross-sectional profile of one screw element may be predetermined, the cross-sectional profile of the other screw element being easy to derive from this predetermined profile. The screw profiles or screw elements are also referred to here for the sake of simplicity as corresponding profiles or elements. In this case, the generating profile or profile to be predetermined only has to comply with a few, easy-to-satisfy criteria. The derivation or generation of the profile of the corresponding screw element takes place in an easy way either graphically or computationally. This allows the construction of an extraordinary variety of corresponding screw elements. A curve that describes the cross-sectional profile of a screw element must comply with the following criteria in order that a cross-sectional profile of a corresponding screw element can be generated from the curve: the curve must be closed, the curve must be continuous, the curve must be convex, the curve must be continuously differentiable in portions and the curve must have at each point a radius of curvature that is less than or equal to the centerline distance a between the screw elements.

In a preferred embodiment of the invention, the generating cross-sectional profile of the one screw element is formed in a plane by a curve \vec{p} that is continuous, continuously differentiable in portions, closed and convex and the generated cross-sectional profile of the other screw element is formed from the curve \vec{q} according to the following relationship (1):

\vec{q}=\vec{p}+a·\vec{n}(\vec{p})+\vec{a} (1),

where
the curve \vec{p} has at each point a radius of curvature ρ that is less than or equal to the centerline distance a between the screw elements,
for each point of the curve \vec{p} within a continuously differentiable portion there exists a normalized normal vector \vec{n}(\vec{p}) with the length 1, which at the respective point is perpendicular to the tangent to the curve \vec{p} and points in the direction of the center point of curvature belonging to the respective point of the curve \vec{p},
\vec{α} is a vector which leads in the direction from the point of rotation of the generating profile to the point of rotation of the generated profile in the cross-sectional plane and has the length a.

In this connection, the curve \vec{p} may in portions be described by a single mathematical function. Functions that may be mentioned as examples are those known to a person skilled in the art, such as circular functions or elliptical functions, parabolic functions or hyperbolic functions. It is also possible, for example, to represent functions in the form:

$$\vec{p} = ( {r}_{0} - f ( s ) ) \cdot ( \begin{matrix}cos ( s ) \\ sin ( s )\end{matrix} ) + ( \begin{matrix}{x}_{0} \\ {y}_{0}\end{matrix} )$$

whereby, depending on the form of the function f(s), when actually providing screw elements between a barrel with a radius r₀ and the rotating screw element, ‘a gap of a freely selectable form is obtained. The function f(s) may be for example, a linear function or a quadratic function of s, a hyperbolic function or an exponential function.

Also mentioned are functions of which the values are determined by control points, such as for example B-spline functions, Bezier functions, rational Bezier functions and non-uniform rational B-splines (NURBS). Bezier functions, rational Bezier functions and NURBS are preferred, because they are often used in construction with CAD systems (CAD=Computer Aided Design), where they are used especially for defining any desired forms in a geometrically graphic form by shifting control points. Particularly preferred are quadratic and cubic (i.e. where n=2 and n=3) Bezier functions and cubic rational Bezier functions.

Bezier functions are to be cited here as an example. As is known, Bezier functions have the form

\vec{C}(t)=Σᵢ₌₀ⁿB_{i,n}(t)\vec{P}ᵢ

where \vec{P}ᵢ is the coordinates of the control points and

$${B}_{i , n} ( t ) = ( \begin{matrix}n \\ i\end{matrix} ) {{t}^{i} ( 1 - t )}^{n - i}$$

is a Bernstein polynomial.

As is known, rational Bezier functions of the degree n, which are described for example in M. S. Floater: “Derivatives of Rational Bezier Curves”, Comp. Aid. Geom. Design 9, 1992, 161-174, have the form

$$\vec{P} ( t ) = \frac{{\sum }_{i = 0}^{n} {B}_{i , n} ( t ) {w}_{i} {\vec{P}}_{l}}{{\sum }_{i = 0}^{n} {B}_{i , n} ( t ) {\vec{P}}_{l}}$$

where \vec{P}ᵢ represents the coordinates of the control points of the function and wᵢ represents their weighting.

Similarly, the curve \vec{p} can be described in portions by various mathematical functions, the portion-based functions preferably corresponding to the functions mentioned in the previous paragraph. A special case of the portion-based description by mathematical functions, is represented by the description using arcs of a circle. That is to say that it is possible to describe a part or the entire curve \vec{p}—and consequently a part or the generating cross-sectional profile of the one screw element—by arcs. It follows from the above relationship (1), specifically \vec{q}=\vec{p}+a·\vec{n}(\vec{p})+\vec{α}, that in this case the curve \vec{q}, and consequently the generated cross-sectional profile of the other screw element, is also made up of arcs of a circle.

The curve \vec{p} must be continuously differentiable, at least in portions. At the boundaries of the portions of a curve \vec{p} that is defined in portions, the individual portions consequently do not have to merge into one another in a continuously differentiable manner If two portions of a curve meet each other at a kink point, no tangent vector and no normal vector is defined for the kink point or kink location. Accordingly, the above relationship (1) does not directly give for the kink location of the profile of the one screw element the corresponding portion of the curve \vec{q} of the other screw element.

For each kink in the cross-sectional profile of the one screw element there corresponds an arc in the profile of the other screw element. The size of an arc is given by specifying its center angle and its radius. Hereinafter, the center angle of an arc of a circle is referred to as the angle of an arc for short. The position of an arc is given by the position of its center point and by the position of its two end points. An arc corresponding to a kink in the cross-sectional profile of the one screw element in the cross-sectional profile of the other screw element always has a radius that corresponds in size to the centerline distance a. Furthermore, an arc corresponding to a kink always has an angle that corresponds to that angle at which the tangents to the curve portions meet at the kink point. It conversely applies correspondingly that a corresponding profile portion of the curve \vec{q} is a “kirk” if a profile portion of the curve \vec{p} an arc of a circle with the radius a.

To this extent, it is advantageous to describe a kink by an arc of which the radius is equal to 0. At a kink, there is a transition of a first curve portion into a second curve portion by rotation about the angle of the arc of the circle with radius zero. A tangent to the first curve portion at the center point of the arc of the circle with radius zero intersects a tangent to the second curve portion likewise at the center point of the arc of the circle at an angle that corresponds to the angle of the arc of the circle. Taking the arc of the circle into consideration, all of the adjacent curve portions (first curve portion→arc with radius zero→second curve portion) merge tangentially into one another. An arc with a radius of zero is expediently treated like an arc of which the radius is equal to eps, where eps is a very small positive real number that tends toward 0 (eps<<1, eps→0). On the corresponding cross-sectional profile there occurs an arc with the same angle and a radius=centerline distance. This situation is illustrated in WO2011/069896 A1 (WO2011/069896 A1, page 8, lines 5-11).

In preferred embodiments of the invention, the profiles of the screw elements can therefore also be described exclusively by an arrangement of arcs. The screw profile of generating and generated screw elements according to the invention is made up in its entirety of n arcs, where n is greater than or equal to four. Each of the n arcs has a starting point and an end point. Some of the arcs may merge tangentially into one another at their starting and end points, so that they partially form a continuously differentiable profile curve. At the location of the kink or the abrupt change in slope or the geometrical discontinuity in the slope of the profile curve, however, the respective arcs do not merge tangentially into one another but meet one another at an angle, preferably at an angle of between 90° and 180°, more preferably of between 120° and 180°, and still more preferably of between 140° and 180°.

The position of each arc j (j=1 to n) can be definitively fixed by specifying two different points. The position of an arc is expediently fixed by specifying the center point and/or the starting point or end point. The size of an individual arc j is fixed by the radius rⱼ and the angle αⱼ about the center point between the starting point and the end point, the radius rⱼ being greater than 0 and less than the centerline distance a between the shafts and the angle αⱼ in radians measure being greater than or equal to 0 and less than or equal to 2π, where π is the constant of a circle.

In a preferred embodiment of the invention, the screw elements are characterized in t a
the generating screw profile and the generated screw profile lie in one plane,
the axis of rotation of the generating screw profile and the axis of rotation of the generated screw profile are in each case perpendicular to said plane of the screw profiles at a distance a (centerline distance), the point of intersection of the axis of rotation of the generating screw profile with said plane being referred to as the point of rotation of the generating screw profile and the point of intersection of the axis of rotation of the generated screw profile with said plane being referred to as the point of rotation of the generated screw profile,
the number of arcs of the entire generating screw profile n is greater than or equal to four (n≧4),
the outer radius ra of the generating screw profile is greater than zero (ra>0) and less than the centerline distance a (ra≦a),
the core radius ri of the generating screw profile is greater than zero (ri>0) and less than or equal to the outer radius ra (ri≦ra),
the arcs form a closed screw profile, i.e. the sum of the angles αⱼ of all of the arcs j is equal to 2π; where π is the constant of a circle (π≈3.14159),
the arcs form a convex screw profile,
each of the arcs of the generating screw profile lies within or on the limits of a circular ring with the outer radius ra and the core radius ri, the center point of which lies on the point of rotation of the generating screw profile,
at least one of the arcs of the generating screw profile makes contact with the outer radius ra of the generating screw profile at a point P_{A},
at least one of the arcs of the generating screw profile makes contact with the core radius ri of the generating screw profile at a point P_{I},
the number of arcs n′ of the generated screw profile is equal to the number of arcs n of the generating screw profile,
the outer radius ra′ of the generated screw profile is equal to the difference between the centerline distance and the core radius of the generating screw profile (ra′=a−ri),
the core radius ri′ of the generated screw profile is equal to the difference between the centerline distance and the outer radius of the generating screw profile (ri′=a−ra),
the angle αⱼ′ of the j′th arc of the generated screw profile is equal to the angle αⱼ of the jth arc of the generating screw profile, where j and j′ are whole numbers which jointly run through all values in the range from 1 to the number of arcs n or n′,
the sum of the radius rⱼ′ of the jth arc of the generated screw profile and the radius rⱼ of the jth arc of the generating screw profile is equal to the centerline distance a, where j and j′ are whole numbers which jointly run through all values in the range from 1 to the number of arcs n or n′,
the center point of the j′th arc of the generated screw profile is at a distance from the center point of the jth arc of the generating screw profile that is equal to the centerline distance a, and the center point of the j′th arc of the generated screw profile is at a distance from the point of rotation of the generated screw profile that is equal to the distance of the center point of the jth arc of the generating screw profile from the point of rotation of the generating screw profile, and the joining line between the center point of the j′th arc of the generated screw profile and the center point of the jth arc of the generating screw profile is a line parallel to a joining line between the point of rotation of the generated screw profile and the point of rotation of the generating screw profile, where j and j′ are whole numbers which jointly run through all values in the range from 1 to the number of arcs n or n′,
the starting point of the j′th arc of the generated screw profile lies in a direction with respect to the center point of the Ph arc of the generated screw profile that is opposite the direction that a starting point of the jth arc of the generating screw profile has with respect to the center point of the jth arc of the generating screw profile, where j and j′ are whole numbers which jointly run through all values in the range from 1 to the number of arcs n or n′.

In a preferred embodiment of the invention, the profiles of screw elements according to the invention are characterized in that they can be constructed with a set square and a pair of compasses. A tangential transition between the jth arc and the (j+1)th arc of the generating screw profile can be constructed by describing a circle with the radius rⱼ₊₁ about the end point of the jth arc and by the point of intersection of this circle with this straight line defined by the center point and the end point of the jth arc that is situated closer to the point of rotation of the generating screw profile being the center point of the (j+1)th arc. In a more practical way, a computer program will be used for constructing the screw profiles instead of a set square and a pair of compasses.

The screw elements according to the invention may be symmetrical or unsymmetrical; preferably, screw elements according to the invention are symmetrical. Symmetrical screw elements may be axisymmetric or point-symmetric; preferably, screw elements according to the invention are axisymmetric. The screw elements preferably have in each case two locations of discontinuity along the profile curve within an outer radius of the profile curve, for example offset from one another at an angle of 180° or π in radians measure about the profile curve. Each of these locations preferably lies on a discharge side of a flight land of the profile curve.

In a preferred embodiment of the invention, the number of flights Z of such axisymmetric screw elements according to the invention is in the range from 2 to 8; particularly preferably 2 to 4. The profile curve of the cross section of symmetrical screw elements according to the invention can consequently be subdivided into profile portions, which are transferred into one another by point or axis mirroring at the centers or axes of symmetry of the profile. The number of arcs n that form one of the profile portions preferably lies in the range from 2 to 8, particularly preferably in the range from 3 to 6.

The profile curve of the cross section of axisymmetric screw elements according to the invention can preferably be subdivided into 2·Z profile portions, which can be transferred into one another by axis mirroring at the axes of symmetry of the profile. On account of its symmetry, the profile of an axisymmetric screw element with a number of flights Z can therefore be completely defined by a profile portion in a segment of 360°/(2·Z) that lies between two axes of symmetry of the profile. The remaining profile is obtained by mirroring of the profile portion at the Z axes of symmetry which intersect at the point of rotation and subdivide the angle of 360° about the point of rotation into 2·Z angles of the size 360°/(2·Z). In the case of axisymmetric screw elements, furthermore, the corresponding screw profiles on adjacent shafts (generating profile and generated profile) are the same, or can be made to coincide by rotation. The same applies analogously to point-symmetric screw profiles, in which the symmetrical parts can be transferred into one another respectively by point mirroring at the center of symmetry.

In a preferred embodiment of the invention, the profile portion of an axisymmetric screw element according to the invention is characterized in that, between a point P_{A}, which lies on the outer radius of the profile, and a point P_{I}, which lies on the core radius of the profile, it is made up of arcs of a circle. The arcs merge into one another and form over the greatest part of the profile portion a continuously differentiable curve, but the profile portion comprises at least one location at which the arcs do not merge tangentially into one another but form a kink or meet at an angle of between 90° and 180°. In a particularly preferred embodiment, a profile portion of a screw element according to the invention between the points P_{A} and P_{I} is made up of precisely three arcs. With three arcs, the profile can be made more slender in the region of the point P_{A}, which cleans off the barrel wall, by choosing a small radius, whereby the energy dissipation is further reduced.

In another embodiment of the invention, a point-symmetric screw profile with a number of flights Z can be divided into Z symmetrical parts: it being possible for the symmetrical parts to be transferred into one another by point mirroring at the center of symmetry or at the point of rotation of the profile. In the case of point-symmetric screw elements, the corresponding screw profiles on adjacent shafts (generating profile and generated profile) are the same, or can be made to coincide by rotation.

In a preferred embodiment of the invention, the profile portion of a screw element according to the invention is characterized in that it is made up of a number of arcs which merge tangentially into one another and form a continuously differentiable curve between two locations at which the respective arc does not merge tangentially into the adjacent profile portion but meets it at an angle, preferably at an angle of between 90° and 180°, more preferably at an angle of between approximately 120° and 180°, and still more preferably at an angle of between approximately 140° and 180°. In other words, the end points of each profile portion in this embodiment form the kink locations in the profile curve.

In a preferred embodiment of the invention, the ratio of the outer radius ra of the screw element to the centerline distance a for double-flighted screws according to the invention is between 0.54 and 0.7 and particularly preferably between 0.58 and 0.63, for triple-flighted screws between 0.53 and 0.57 and particularly preferably between 0.54 and 0.56, and for quadruple-flighted screws between 0.515 and 0.535.

The screw elements according to the invention may be formed as conveying elements or kneading elements or mixing elements.

As is known (see for example [1], pages 243-237), a conveying element is distinguished by the fact that the screw profile is continuously turned in a helical manner and continued in the axial direction. In this case, the conveying element may be right-handed or left-handed. The pitch t of the conveying element may, for example, assume values of 0.1 to 10 times the outside diameter, the pitch being understood as meaning the axial length that is required for a complete rotation of the screw profile. The pitch t preferably lies in the range of 0.3 to 3 times the outside diameter. For practical reasons, the axial length of a conveying element is preferably configured as an integral multiple of t/Z.

As is known (see for example [1], pages 237-240), a kneading element is distinguished by the fact that the screw profile is continued in the axial direction in an offset manner in the form of kneading disks. The arrangement of the kneading disks may be right-handed or left-handed or neutral. The axial length of the kneading disks is preferably in the range of 0.02 to 2 times the outside diameter. The axial distance between two adjacent kneading disks preferably lies in the range of 0.001 to 0.1 times the outside diameter.

As is known (see for example [1], pages 242-244), mixing elements are formed by conveying elements being provided with apertures in the flight lands of the screws. The mixing elements may be right-handed or left-handed. Their pitch t preferably lies in the range of 0.1 to 10 times the outside diameter. By analogy with the conveying elements, the axial length of a mixing element is preferably configured as an integral multiple of t/Z. The apertures preferably have the form of a u-shaped or v-shaped groove. If the mixing element is formed on the basis of an actively conveying clement, the grooves are preferably arranged counter-conveying or axially parallel.

The subject matter of the present invention also comprises a method for producing the screw elements according to the invention, which are always in contact with one another at at least one point when rotating in the same direction at the same rotational speed about two axes of rotation arranged parallel to one another at a distance a.

In a preferred embodiment of the method, the (generating) cross-sectional profile of the one screw element is formed in a plane E perpendicular to the axes of rotation by a curve \vec{p} that is continuous, continuously differentiable in portions, closed and convex and the (generated) cross-sectional profile of the other screw element is formed from the curve \vec{q} according to the following relationship (1):

\vec{q}=\vec{p}+a·\vec{n}(\vec{p})+\vec{a} (1),

where
the curve \vec{p} has at each point a radius of curvature ρ that is less than or equal to the centerline distance a between the screw elements,
for each point of the curve \vec{p} within a continuously differentiable portion there exists a normalized normal vector \vec{n}(\vec{p}) with the length 1, which at the respective point is perpendicular to the tangent to the curve \vec{p} and points in the direction of the center point of curvature belonging to the respective point of the curve \vec{p},
\vec{α} is a vector which leads in the direction from the point of intersection of the axis of rotation of the generating profile with the plane E to the point of intersection of the axis of rotation of the generated profile with the plane E and has the length a.

The generation of the respective profiles in accordance with the above formula can be demonstrated on the basis of a point on a curve \vec{p}. The profile curves \vec{p}, \vec{q} are generated in a plane perpendicular to the axes of rotation of the screw elements. The axes of rotation are at a distance a from one another. The vector a has the length a and points in the direction from one axis of rotation to the other. From each point of the profile curve \vec{p} of the one (generating) profile, a point on the corresponding curve \vec{q} of the other (generated) profile can be generated. The point on the corresponding curve \vec{q} is obtained by placing a tangent \vec{t}(\vec{p}) to the curve at the point of the curve \vec{p}, forming with respect to this tangent the normalized normal vector \vec{n}(\vec{p}) and extending it by the factor a {that is to say, a·\vec{n}(\vec{p})} and finally adding to this vector a·\vec{n}(\vec{p}) the vector \vec{α}.

As already explained above, screw elements in a preferred embodiment of the invention are distinguished by a profile which is made up of arcs of a circle to form a curve which has at least one kink location or a location of discontinuity of the slope along it, this at least one location lying within an outer radius of the profile curve. Therefore, the method according to the invention for producing screw elements for multi-shaft screw machines with paired co-directional and paired fully wiping screw shafts at a centerline distance a with two or more screw flights preferably has screw profiles that are formed in the entire cross section by n arcs, where n is a whole number greater than or equal to 4.

The method according to the invention for producing screw profiles according to the invention is preferably characterized in that
an outer radius ra of the generating screw profile is chosen to be greater than 0 (ra>0) and less than the centerline distance a (ra<a),
a core radius ri of the generating screw profile is chosen to be greater than 0 (ri>0) and less than or equal to the outer radius ra (ri≦ra),
the arcs are arranged one after the other by fixing their position and size in such a way that the arcs form a closed, convex screw profile, each of the arcs of the generating screw profile lying within or on the limits of a circular ring with the outer radius ra and the core radius ri, the center points of which lie on the point of rotation of the generating screw profile, at least one of the arcs of the generating screw profile making contact with the outer radius ra of the generating screw profile at a point P_{A} and at least one of the arcs of the generating screw profile making contact with the core radius ri of the generating screw profile at a point P_{I},
the n′ arcs of the generated screw profile result from the n arcs of the generating screw profile in that
   the number of arcs n′ of the generated screw profile is equal to the number of arcs n of the generating screw profile,
   the outer radius ra′ of the generated screw profile is equal to the difference between the centerline distance a and the core radius ti of the generating screw profile (ra′a−ri),
   the core radius rid of the generated screw profile is equal to the difference between the centerline distance a and the outer radius ra of the generating screw profile (ri′=a−ra),
   the angle αⱼ′ of the j′th arc of the generated screw profile is equal to the angle αⱼ of the jth arc of the generating screw profile, where j and j′ are whole numbers which jointly run through all values in the range from 1 to the number of arcs n or n′,
   the sum of the radius rⱼ′ of the j′th arc of the generated screw profile and the radius rⱼ of the jth arc of the generating screw profile is equal to the centerline distance a, where j and j′ are whole numbers which jointly run through all values in the range from 1 to the number of arcs n or n′,
   the center point of the j′th arc of the generated screw profile is at a distance from the center point of the jth arc of the generating screw profile that is equal to the centerline distance a, and the center point of the j′th arc of the generated screw profile is at a distance from the point of rotation C′ of the generated screw profile that is equal to the distance of the center point of the jth arc of the generating screw profile from the point of rotation C of the generating screw profile, and the joining line between the center point of the j′th arc of the generated screw profile and the center point of the jth arc of the generating screw profile is a line parallel to a joining line between the point of rotation of the generated screw profile and the point of rotation of the generating screw profile, where j and jd are whole numbers which jointly run through all values in the range from 1 to the number of arcs n or n′,
   a starting point of the j′th are of the generated screw profile lies in a direction with respect to the center point of the j′th arc of the generated screw profile that is opposite the direction that a starting point of the jth arc of the generating screw profile has with respect to the center point of the jth arc of the generating screw profile, where j and j′ are whole numbers which jointly run through all values in the range from 1 to the number of arcs n or n′.

In the preferred variant, in which the screw profile is made up of arcs of a circle, the method according to the invention can surprisingly be carried out on paper just with a set square and a pair of compasses. With it, it is even possible in principle to produce the cross-sectional profile of one screw element just manually and to derive the cross-sectional profile of the corresponding screw element graphically from the graphically predetermined profile.

However, it is recommendable to carry out the method for producing screw profiles on a computer. Carrying out the method according to the invention on a computer system is advantageous because the coordinates and dimensions of the profiles are in a form that can be further processed by a computer. Furthermore, the dimensions of the screw elements are also then in a form in which they can be fed to a CAD milling machine for producing the screw elements.

The subject matter of the present invention therefore also comprises a computer system for carrying out the method according to the invention for producing screw profiles according to the invention on a computer. The computer system preferably has a graphical user interface (GUI), which allows a user to input in an easy way the freely selectable variables for producing profiles by way of input devices, such as for example a mouse and/or keyboard. Particularly preferably, the computer system has a possibility for specifying contours of profiles with the aid of control points and possibly weightings in the case of functions of which the values are defined by control points, such as for example B-spline functions, Bezier functions, rational Bezier functions and non-uniform rational B-splines (NURBS), it being possible for this to take place in the form of numbers (coordinates), graphically or with a combination of graphical and numerical input. Furthermore, the computer system preferably has a graphical output, by means of which the calculated profiles can be displayed on a graphical output device, such as for example a screen and/or printer.

The computer system preferably has the possibility of exporting calculated profiles, i.e. either storing them on a data carrier in the form of storable data records, which comprise the geometrical dimensions of the calculated screw elements, or transferring them to a connected device for further purposes of use. The computer system is preferably designed in such a way that it can calculate both cross-sectional profiles and screw elements generated from the cross-sectional profiles and can output the calculated geometries in a format that can be used by a machine for producing such bodies, for example a machine tool, for example a milling machine, in order to produce actual screw elements. Such formats are known to a person skilled in the art.

The subject matter of the present invention also comprises a computer program product, with program code means for executing the method according to the invention for producing screw profiles according to the invention on a computer.

In a preferred embodiment of the invention, a user of the computer program product is provided with a user interface, preferably a graphical user interface, with the aid of which he can input the parameters to be chosen (number of arcs of the generating and generated screw profiles, radii, angles). He is preferably assisted in this by the computer system, which indicates to the user when a choice of the parameter values will produce screw profiles that do not fully wipe in pairs. Said user is preferably assisted in the input of the parameter values by ranges of permissible parameter values being displayed. Permissible parameter values are understood as meaning those combinations of parameter values that lead to screw profiles that fully wipe in pairs.

In a preferred embodiment of the invention, not just the profiles but entire screw elements are constructed in virtual reality on the computer. The result of the construction is preferably output in the form of constructional drawings on a screen or on a printer. It is similarly conceivable to output the result as an electronic file, which in a preferred embodiment can be passed on to a CAD milling machine for producing the corresponding screw elements.

Once the three-dimensional profiles have been produced in the way described, the screw elements can be produced, for example by a milling machine, a turning machine or a whirling machine. Preferred materials for producing such bodies are steels, in particular nitriding steels, chromium steels, tool steels and special steels, powder-metallurgically produced metallic composite materials based on iron, nickel or cobalt or engineering ceramic materials, such as for example zirconium oxide or silicon carbide, if the bodies are extruder screws.

The method according to the invention for producing screw profiles according to the invention allows the profile of a screw to be designed from scratch in such a way that it is optimally suited for a given task. The screw elements that are known from the prior art are for the most part not optimally designed for an actual task. Rather, the manufacturers supply screw elements (conveying, kneading and mixing elements) from a fixed modular system independently of an actual task. The method according to the invention for producing screw profiles according to the invention makes it possible for the profile of self-cleaning screw elements to be designed virtually completely freely, and consequently to be optimized with a view to an application by minute variation of parameters for the respective application. It should be pointed out in this connection that the number of arcs for producing screw profiles is not limited. As a result, it is possible for screw profiles that are not constructed from arcs, and consequently are not self-cleaning, to be approximated with a desired accuracy by an adequately high number of arcs. In this case, the profile approximated by means of arcs is of course self-cleaning.

It should also be pointed out that the corresponding longitudinal-sectional profile can be calculated from a (generating or generated) screw profile. Preferably, each arc of a screw profile is used to calculate a part of the longitudinal section belonging to this arc by means of an explicit function. To calculate the distance s of a point of an arc of a screw profile, in a first step the point of intersection (Sx, Sy) of a straight line g is characterized in that said line lies in the plane of the screw profile and passes through the point of rotation of the screw profile and the orientation of the line is given by the angle φ, determined with an arc kb, characterized by its radius r and the position of its center point (Mx, My). In a second step, the distance of the point of intersection (Sx, Sy) from the point of rotation of the screw profile is calculated. The calculation of a point of intersection of a straight line with an arc can be represented by an explicit function. The same applies to the distance calculation. Therefore, s=s(φ, r, Mx, My) is true for the distance. With a known pitch t of a screw element, the angle φ can be converted via φ/2π*t into an axial position z_ax, so that s=s(z_ax, r, Mx, My)=s(φ/2π*t, r, Mx, My) is true for the distance. The function s(z_ax, r, Mx, My) describes the longitudinal section that is sought for an arc of the screw profile.

The subject matter of the present invention further comprises the use of the screw elements according to the invention in multi-shaft screw machines. The screw elements according to the invention are preferably used in two-shaft screw machines. In the multi-shaft screw machines, the screw elements may be in the form of kneading, conveying or mixing elements. It is similarly possible to combine kneading, conveying and mixing elements with one another in a screw machine. The screw elements according to the invention may also be combined with other screw elements that are known for example according to the prior art.

In multi-shaft screw machines with paired co-directional and paired fully wiping screw shafts, the screw elements according to the invention form a channel extending over its entire circumference. In this case, the channel has an alternately increasing and decreasing channel width. Such a channel is referred to herein as a convergent-divergent channel. In such a convergent-divergent channel, during operation a combination of shear flow and stretching flow occurs over its overall length, which has a very good dispersing effect. The energy input is reduced in comparison with conventional screw elements that are known according to the prior art. Eccentrically arranged circular disks likewise form a convergent-divergent channel. However, the screw elements according to the invention have a smaller circumferential region in which there is a very narrow gap than eccentrically arranged circular disks. Therefore, the energy input when using screw elements according to the invention in multi-shaft screw machines is reduced in comparison with the use of eccentrically arranged circular disks. The profiles of the screw elements are preferably displaced in pairs in relation to the point of rotation situated centrally in the barrel bore.

The screw elements according to the invention are suitable for the extrusion of plastic and viscoelastic compositions, for example suspensions, pastes, glass, ceramic compositions, metals in molten form, plastics, polymer melts, polymer solutions, elastomer and rubber compositions.

A plastic composition is understood as meaning a deformable composition. Examples of plastic compositions are polymer melts, in particular thermoplastics, as well as elastomers, mixtures of polymer melts or dispersions of polymer melts with solids, liquids or gases.

Thermoplastic polymers or mixtures of polymers from the following series are preferably used: polycarbonate, polyamide, polyester, in particular polybutylene terephthalate and polyethylene terephthalate, as well as polyether, thermoplastic polyurethane, polyacetal, fluoropolymer, in particular polyvinylidene fluoride, as well as polyether sulfones, polyolefin, in particular polyethylene and polypropylene, as well as polyimide, polyacrylate, in particular poly(methyl) methacrylate, as well as polyphenylene oxide, polyphenylene sulfide, polyether ketone, polyarylether ketone, styrene polymers, in particular polystyrene, and styrene copolymers, in particular styrene-acrylonitrile copolymers and acrylonitrile-butadiene-styrene block copolymers as well as polyvinyl chloride. So-called blends of the listed plastics are likewise preferably used, these being understood by a person skilled in the art as a combination of two or more plastics.

Viscoelastic compositions are understood as meaning those materials and mixtures that have a time-, temperature- and frequency-dependent elasticity. The viscoelasticity is distinguished by a partially elastic, partially viscous behavior. The material relaxes only incompletely after removal of the external force; the remaining energy is dissipated in the form of flow processes (retardation).

Examples of viscoelastic materials are styrene-butadiene rubber, natural rubber, butadiene rubber, isoprene rubber, ethylene-propylene-diene rubber, ethylene-propylene rubber, butadiene-acrylonitrile rubber, hydrogenated nitrile rubber, butyl rubber, halobutyl rubber, chloroprette rubber, ethylene-vinyl acetate rubber, polyurethane rubber, thermoplastic polyurethane, gutta-percha, arylate rubber, fluororubber, silicone rubber, sulfide rubber, chlorosulfonyl-polyethylene rubber. A combination of two or more of the listed rubbers or a combination of one or more rubber with one or more plastics is of course also possible.

The plastic or viscoelastic polymers to be extruded may be used in a pure form or as mixtures with fillers and reinforcing materials, such as in particular glass fibers, as mixtures with one another or with other polymers or as mixtures with customary polymer additives.

Additives may be introduced into the extruder as solids, liquids or solutions together with the polymer, or else at least some of the additives or all of the additives are fed to the extruder by way of a side stream.

Additives can lend a polymer various properties. They may be, for example, plasticizers, colorants, pigments, processing aids, fillers, antioxidants, reinforcing materials, UV absorbers and light stabilizers, extender oils, metal deactivators, peroxide scavengers, basic stabilizers, nucleating agents, benzofurans and indolinones active as stabilizers or antioxidants, mold release agents, flame-retardant additives, antistatic agents, dye preparations and melt stabilizers. Examples of fillers and reinforcing materials are carbon black, glass fibers, clay, mica, graphite fibers, titanium dioxide, carbon fibers, carbon nanotubes, ionic liquids and natural fibers.

As stated above, the screw elements according to the invention are particularly suitable for the extrusion of viscoelastic compositions. The method steps that can be carried out with the aid of these elements are for example the mixing in or dispersing of solids or liquids or gases. Solids may be for example the aforementioned solid additives. Liquids may be for example the aforementioned additives in liquid form, but also for example water. Gases may be for example nitrogen or carbon dioxide. The subject matter of the present invention therefore also comprises a method for extruding viscoelastic compositions in a twin-screw or multi-shaft extruder using screw elements according to the invention.

The invention is explained below by way of example with reference to the accompanying drawings on the basis of preferred exemplary embodiments, it being possible for the features that are presented below to represent an aspect of the invention both individually in each case and in combination. In the drawing:

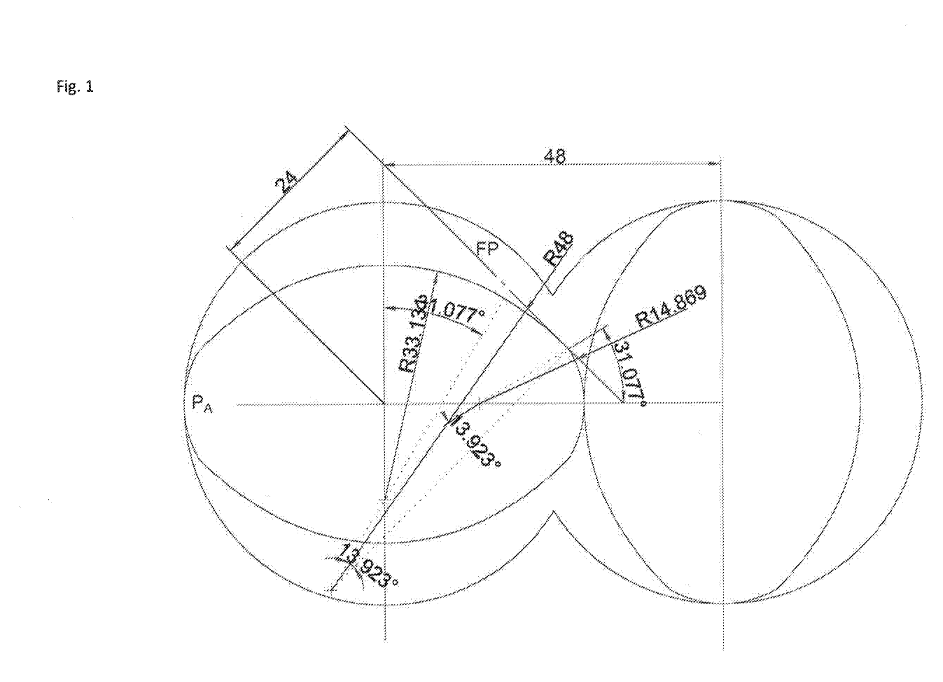

FIG. 1 shows profile curves of screw elements according to the invention in a multi-shaft screw machine according to an exemplary embodiment of the invention;

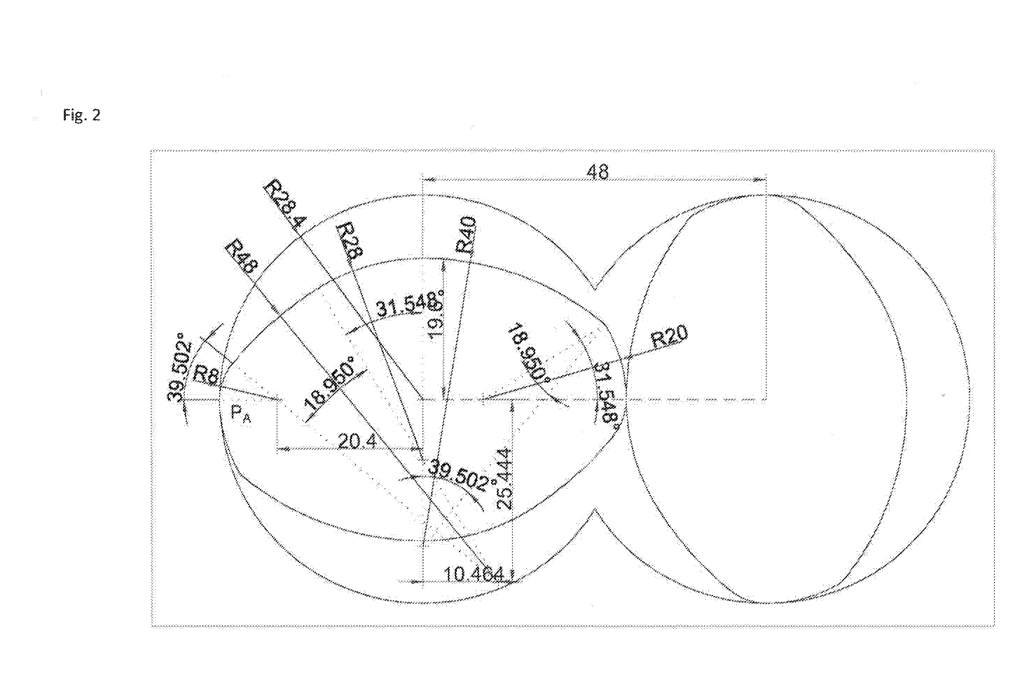

FIG. 2 shows profile curves of screw elements according to the invention in a multi-shaft screw machine according to a further exemplary embodiment of the invention;

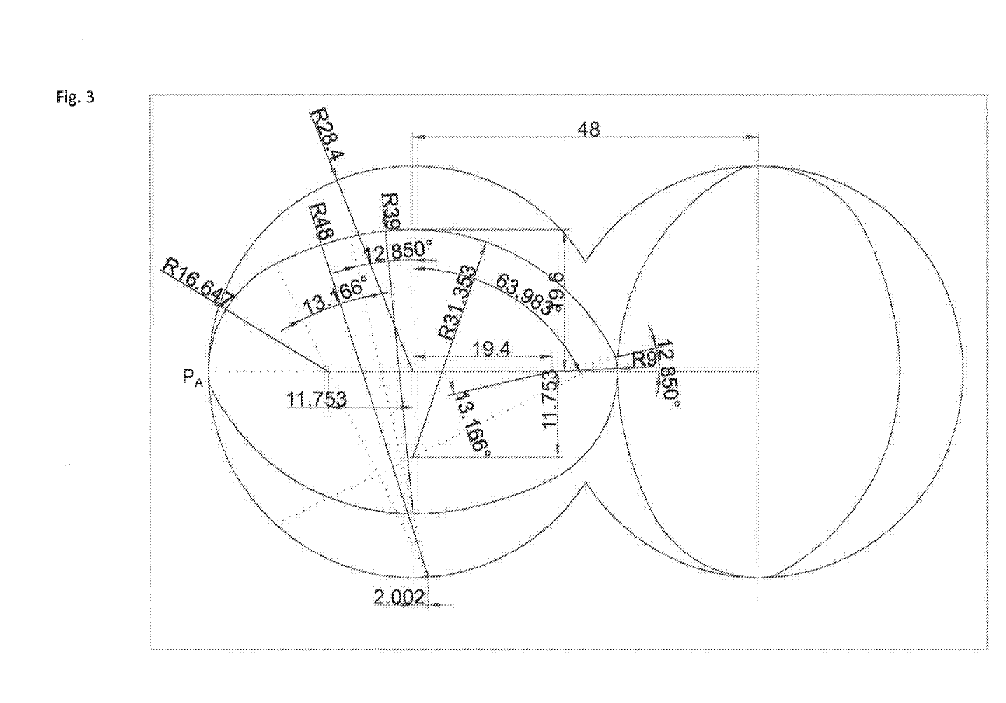

FIG. 3 shows profile curves of screw elements according to the invention in a multi-shaft screw machine according to a modification of the exemplary embodiment in FIG. 2.

For practical reasons, the further description is to be based on a system of Cartesian coordinates of which the origin is formed by the point of rotation C of a screw element.

The x-axis of the system of Cartesian coordinates passes through the point P_{A}; the y-axis is perpendicular to the x-axis at the point of rotation C. Such a system of coordinates is shown in FIG. 1.

It is advisable to use dimensionless characteristic values, to make transferability to different extruder sizes easier. Suitable as a reference value for geometrical variables, such as for example lengths or radii, is the centerline distance A, since this value cannot be changed on an extruder.

The following conventions apply to the figures: the coordinates x and y have their origin at the point of rotation of one of the shafts. All specified angles are given in radians measure. All other specifications are normalized to the centerline distance and are represented by capital letters: A=a/a; Rⱼ=rⱼ/a; RA=ra/a; RJ=ri/a T=t/a, and so on. Mx and My are the x and y coordinates of the center point of the circle of a profile-generating arc, R is the radius normalized to the centerline distance a and α is the angle of the arc. Furthermore, RG=normalized barrel radius, RV=normalized virtual barrel radius, RA=normalized outer radius of the fully wiping profile, RF=normalized outer radius of the screw to be produced, S=normalized clearance of the screws with respect to one another (gap), D=normalized clearance of the screw with respect to the barrel. VPR=notinalized amount of the profile displacement, VPW=angle of the profile displacement in radians measure, VLR=normalized amount of the displacement of the shaft on the left, VLW=angle of the displacement of the shaft on the left, VRR=normalized amount of the displacement of the shaft on the right. VRW=angle of displacement of the shaft on the right.

FIG. 1 shows in cross section two fully wiping, double-flighted screw elements 10, 10′ according to the invention, which are arranged at a distance A from one another and respectively have a generating and a generated profile 11, 11′. The points identified by C and C′ indicate the points of rotation of the profiles 11, 11′ or the axes of rotation of the shafts W, W′ on which the screw elements are arranged. The point of rotation C of the generating screw element 10 is located at the distance A from the point of rotation C′ of the corresponding (generated) screw element 10′. In this and all other figures, the coordinate origin marks the point of rotation C of the shaft W. There can be drawn around the point of rotation C a circle (inner circle) with the core radius RI and a circle (outer circle) with the outer radius RA of the screw element 10. The inner circle and the outer circle form a circular ring. With the outer radius RA, a circle can be drawn around the profile. The barrel bore 12 is represented by a circle concentric thereto with a radius RG that is increased with respect to the outer radius RA by the clearance D (that is to say RG=RA+D).

The screw element 10 has a number of flights Z=2 and a convex profile curve 11, which is formed by a number of arcs. The profile curve 11 can be subdivided into 2·Z, that is to say four, profile portions, which can be transferred into one another by axis mirroring at the axes of symmetry of the profile. In this way, the profile 11 of the screw element 10 can be completely defined by a profile portion in a segment of 360°/(2·Z), that is to say 90°, which lies between two axes of symmetry of the profile. The generating profile 11 shown in FIG. 1 is axisymmetric in relation to the x-axis and the y-axis, so that the entire profile 11 would he obtained by mirroring the quarter between the points P_{A} and P_{I} at the x-axis and the y-axis. All points of the profile portion between the points P_{A} and P_{I} and also of the resultant overall profile 11 of the screw element 10 lie in the circular ring between the core radius RI and the outer radius RA. The profile 11 is distinguished by the fact that within a profile portion in a segment of 90° there is only a single point P_{A} that is at a distance from the point of rotation C that corresponds to the outer radius RA of the screw element 10. To put it another way, there is only one point P_{A} in the profile portion that lies on a circle around the point of rotation C with the outer radius RA (outer circle). By continuous mirroring of the profile portion between P_{A} and P_{I} on a straight line which passes through the points C and P_{A} (that is to say the x-axis) and on a straight line which passes through the points C and P_{I} (that is to say the y-axis), the overall profile 11 of the (generating) screw element 10 can be constructed. The profile 11′ of the corresponding (generated) screw element 10′ is then obtained by rotating the profile 11 of the screw element 10 by an angle of 90°.

For producing the profile portion between the points P_{A} and P_{I}, the point P_{A} identifies a starting point of a first arc 1 with a radius R₁<RA and with a center point M₁, which lies on the joining line C-P_{A}. The point P_{A} lies on the outer circle, Point P_{I} identifies a starting point of an arc 3 with a radius R₃=A−R₁. Its center point M₃ lies on the line C-P_{I}. Between the arc 1 and the arc 3 there adjoins an arc 2 with the radius R₂=A and a center point M₂ in such a way that the arc 2 merges tangentially into the arc 3 but forms a kink location K at an angle θ with the arc 1, so that the kink location K represents a geometrical discontinuity in the slope of the profile curve 11. The angle θ preferably lies in the range between 140° and 180°.

With reference now to FIG. 2, shown in cross section are two fully wiping, double-flighted screw elements 10, 10′ according to the invention, which are arranged at a distance A from one another and in which the profile portions cannot be made to coincide by axis minoring but in which the profile portions are point-symmetric in relation to the points of rotation C, C′, so that the entire screw profile 11, 11′ is obtained by mirroring one half at the point of rotation C or C′. The screw elements 10, 10′ consequently have the same point-symmetric screw profile 11, 11′ in the form of a generating profile and a generated profile. The screw element on the right 10′ is turned with respect to the screw element on the left 10 by 90°. Each of the screw profiles 11, 11′ shown is made up of two symmetrical profile portions and at the transitions of the portions there are kinks K, K′, which are identified by an arrow.

For producing the profile portion, the point P_{A} may identify a starting point of a first arc 1 with a radius R₁<RA and a center point M₁, which lies on the joining line C-P_{A}. The point P_{A} lies on the outer circle. Point P_{I} identifies a starting point of an arc 2 with a radius R₂ and a center point M₂, which lies on the line C-P_{I}. The arc 2 adjoins the arc 1 in such a way that the arcs 1, 2 meet one another at an angle θ and form a kink location K, which represents a geometrical discontinuity in the slope of the profile curve 11. The angle θ preferably lies between 140° and 180°. The point P_{I} also identifies a starting point of an arc 3 with a radius R₃=A−R₁ and a center point M₃, which likewise lies on the line C-P_{I}, so that the arc 2 merges tangentially into the arc 3. The arc 3 then merges tangentially into a further arc 4 with a radius R₄=A and a center point M₄ and half of the profile curve 11 is supplemented by a final arc 5 with respect to the opposite point P_{A} on the outer circle. The arc 5 has a radius R₅=A−R₂ and a center point M₅, which lies on the line P_{A}-C, and runs tangentially out of the arc 4 to the point P_{A}.

The upper half of the profile curve 11, which runs between the points P_{A}-P_{A} and is formed by the series of arcs 1-2-3-4-5, corresponds to the lower half of the profile curve 11, which can be generated by point minoring of the other half at the point of rotation C. Nevertheless, the screw profiles 11, 11′ in this exemplary embodiment can be imagined as the profile curves comprising two continuously differentiable halves that respectively comprise a) series of arcs 2-3-4-5-1 merging tangentially into one another and meet at the respective kink locations K, K′. That is to say that the kink locations K, K′ can also be regarded as the end points of the respective profile portions. This can be imagined better on the basis of the dashed line through the kink locations K′ and the point of rotation C′ of the generated screw profile 11′ in FIG. 2. As such, each profile portion may be made up of a number of arcs 1-5 which merge tangentially into one another and form a continuously differentiable curve between two kink locations K, K′. At the kink locations K, K′, the respective arcs do not merge tangentially into the adjacent profile portion but are at the angle θ to one another.

A further embodiment of screw elements according to the invention is represented by way of example in FIG. 3. It is a modification of the exemplary embodiment in FIG. 2 with somewhat different dimensions, but has in principle the same point-symmetric structure with five arcs 1-5 and two kink locations K, K′.

Screw elements for a screw machine or for a twin-screw or multi-shaft extruder are usually fitted in a barrel. In this case, the screw elements and the barrel are configured in such a way that not only a wiping of adjacent screw elements in pairs is brought about by the rotation of the screw elements but there is also a cleaning off of the inner walls of the barrel as a result of the rotation of the screw elements. Until now, only fully wiping screw profiles have been discussed. However, in the case of technically configured machines it is necessary to depart from the fully wiping geometry, provided that exactly defined gaps S and D are maintained during cleaning, the term cleaning being used synonymously with wiping in the context of the present invention. This is necessary to prevent metallic “seizing”, to compensate for production tolerances and to avoid excessive energy dissipation in the gaps.

As shown, for example, in the publication [1] pages 27 to 30, arrangements comprising screw elements and a barrel always have in practice what are known as clearances. As known to a person skilled in the art, the clearances between a screw and a barrel and between a screw and a screw may be of different sizes or the same size. The clearance between a screw and a barrel is denoted by “δ”, the clearance between a screw and a screw is denoted by “s”. The clearances may also be constant or variable, within the specified limits. It is also possible to displace a screw profile within the clearances. Consequently, on account of the clearances that are present, the screw elements used in practice do not strictly speaking have the properly that they are in contact with one another at at least one point when rotating in the same direction at the same rotational speed about axes arranged parallel to one another. Nevertheless, as stated in [1], for producing screw elements in practice the fully wiping contours (profiles) are usually taken as a basis and clearances are then introduced. According to the invention, accordingly, at first screw elements that are always in contact with one another at at least one point when rotating in the same direction at the same rotational speed about axes arranged parallel to one another are preferably virtually produced. On the basis of these preferably virtual geometries, clearances are provided, preventing the screw elements that are used in practice from “seizing”, i.e. the screw elements scraping against one another and at the same time destroying their surface.

A person skilled in the art knows methods for deriving a screw profile with clearances from a predetermined, fully wiping screw profile. Known methods for this are for example the possibility described in [1] on page 28 et seq. of increasing the centerline distance, the longitudinal-sectional equidistants, and the spatial equidistants. In the case of increasing the centerline distance, a screw profile of a smaller diameter is constructed and pulled apart by the amount of clearance between the screws. In the case of the method of longitudinal-sectional equidistants, the longitudinal-sectional profile curve (parallel to the axis of rotation of the respective element) is displaced inward perpendicularly to the profile curve, in the direction of the axis of rotation, by half the screw-screw clearance. In the case of the method of spatial equidistants, starting from the space curve in which the screw elements clean one another, the screw element is reduced in size by half the screw-screw clearance in the direction perpendicular to the surfaces of the fully wiping profile. Eccentric positioning of screw elements in a barrel while retaining the barrel wiping and wiping in pairs is also known to a person skilled in the art from extruder technology (see for example [1] pages 108, 246 and 249). The rules for producing screw profiles with defined gaps S and the use of barrels, clearances and/or eccentric positioning can be applied in a corresponding way to screw elements 10, 10′ according to the invention, which scrape against one another when rotating in the same direction about two axes arranged parallel to one another in such a way that they are always in contact with one another at at least one point.

In FIGS. 1 to 3, double-flighted screw elements 10, 10′ were dealt with exclusively. However, the same principles can also be applied to screw elements with three or more flights. The procedure in the case of triple-flighted screw elements is analogous to the procedure in the case of double-flighted profiles. The outer radius of the profile is reduced in comparison with the barrel radius and the profile is displaced in pairs, the point of rotation being maintained centrally with respect to the barrel. For the triple-flighted profiles, eccentrically rotating profiles can also be constructed. Of particular interest are screw profiles in the case of which the screws clean one another completely and where the barrel is cleaned by only one of three flight lands. The creation of gaps in the mutual cleaning of the profiles and in the cleaning of the barrel takes place in a way fully coinciding with the procedure in the case of the double-flighted profiles. The triple-flighted profiles can be used according to the invention as a continuous conveying thread or as kneading disks.

Axisymnietric quadruple-flighted screw profiles can be completely defined by a 45° portion of the screw profile. The production of eccentric profiles and the creation of gaps in the cleaning takes place in a manner similar to the case of the double-flighted and triple-flighted profiles and is not shown here. The quadruple-flighted profiles can likewise be used as a continuous conveying thread or as kneading disks. Profiles according to the invention with more than four flights can be produced in an analogous way. Similarly, the gaps can be varied and eccentric profiles produced in an analogous way.

FIG. 4 schematically shows the profiles of screw elements fully wiping in pairs from the prior art, known as Erdmenger profiles ([1], pages 227-228). It can be clearly seen that the kink locations (K1-K4) lie on the outer radius RA of the profile curve. Such an arrangement crucially has the effect that the polymer composition is heated up, and so potentially contributes to thermal degradation, without providing any contribution to the process task of dispersion.

1.-15. (canceled)

16. Screw elements (10, 10′) for multi-shaft screw machines with paired co-directionally rotating screw shafts (W, W′), these screw elements being fully wiping in pairs and screw shafts that are made up of these screw elements having two or more screw flights, the screw profiles (11, 11′) being able to be represented over the entire cross section by respective profile curves, characterized in that each profile curve (11, 11′) has at least one kink location (K, K′) along it that lies within an outer radius (RA, RA′) of the profile curve, the ratio of a radius of curvature of the screw profile to the outer radius of the profile being 0.05 to 0.95.

17. The screw elements (10, 10′) as claimed in claim 16, each profile curve being a continuous, closed, convex curve, which is also continuously differentiable apart from the at least one kink location (K, K′).

18. The screw elements (10, 10′) as claimed in claim 17, the profile (11) of the one screw element (10) being formed by a curve \vec{p} and the profile (11′) of the other screw element (10′) being formed from the curve \vec{q} according to the following relationship (1):
\vec{q}=\vec{p}+a·\vec{n}(\vec{p})+\vec{α} (1),
where
the curve \vec{p} has at each point a radius of curvature p that is less than or equal to a centerline distance a between the screw elements (10, 10′),
for each point of the curve \vec{p} within a continuously differentiable portion there exists a normalized normal vector \vec{n}(\vec{p}) with the length 1, which at the respective point is perpendicular to the tangent to the curve \vec{p} and points in the direction of the center point of curvature belonging to the respective point of the curve \vec{p},
\vec{α} is a vector which leads in the direction from the point of rotation (C) of the generating profile (11) to the point of rotation (C′) of the generated profile (11′) and has the length a.

19. The screw elements (10, 10′) as claimed in claim 16, each screw profile or each profile curve (11, 11′) being made up of a number of arcs of a circle (1-5), the respective arcs (1-5) being at an angle (θ) of between 90° and 180°, preferably between 140° and 180°, to one another at the at least one kink location (K, K′).

20. The screw elements (10, 10′) as claimed in claim 16, each screw profile or each profile curve (11, 11′) allowing itself to be subdivided into profile portions, which can be transferred into one another by point or axis mirroring.

21. The screw elements (10, 10′) as claimed in claim 20, each profile portion being made up of a number of arcs of a circle (1-5), the number of arcs (1-5) that form one of the profile portions being preferably 2 to 8, particularly preferably 3 to 6.

22. The screw elements (10, 10′) as claimed in claim 20, one of the profile portions extending between a point (PA, PA′), which lies on the outer radius (RA, RA′) of the profile (11, 11′), and a point (PI, PI′), which lies on the core radius (RI, RI′) of the profile (11, 11′), and comprising the at least one kink location (K, K′).

23. The screw elements (10, 10′) as claimed in claim 20, each profile portion comprising a continuously differentiable curve between two kink locations (K, K′).

24. The screw elements (10, 10′) as claimed in claim 16, the ratio of a radius of curvature of the screw profile to the outer radius of the profile being 0.2 to 0.8, preferably 0.3 to 0.7, particularly preferably 0.35 to 0.65, preferably at the point PA which cleans the barrel.

25. A method for producing screw elements (10, 10′) for multi-shaft screw machines with paired co-directionally rotating screw shafts, these screw elements being fully wiping in pairs and screw shafts that are made up of these screw elements having two or more screw flights, for producing the screw profile (11, 11′) a profile curve being created in a plane perpendicular to the axis of rotation (C, C′), which profile curve has at least one kink location (K, K′) or a location of discontinuity in the slope of the curve along it, this location (K, K′) lying within an outer radius (RA, RA′) of the profile curve.

26. A method for producing screw elements (10, 10′) for multi-shaft screw machines with paired co-directionally rotating screw shafts, these screw elements being fully wiping in pairs and screw shafts that are made up of these screw elements having two or more screw flights, characterized in that, in a first step for producing the screw profiles (11, 11′), a profile curve is created in a plane perpendicular to the axis of rotation (C, C′), which profile curve has at least one kink location (K, K′) or a location of discontinuity in the slope of the curve along it, this location (K, K′) lying within an outer radius (RA, RA′) of the profile curve, and in a second step clearances are introduced.

27. The use of screw elements (10, 10′) as claimed in claim 16 or produced as claimed in claim 25 in a screw machine.

28. The use as claimed in claim 27, the screw elements (10, 10′) cleaning in pairs with a constant gap over their entire circumference, or the screw elements (10, 10′) cleaning in pairs with a gap that is not constant over the entire circumference.

29. A screw machine, in particular an extruder, with paired co-directionally rotating screw shafts (W, W′), the screw shafts having screw elements (10, 10′) as claimed in claim 16 or produced as claimed in claim 25.

30. A method for extruding plastic compositions, characterized in that screw elements as claimed in claim 16 or produced as claimed in claim 28 or a screw machine as claimed in claim 29 are used.
